(19) United States
(12) Patent Application Publication
(10) Pub. No.: US 2003/0150673 A1
(43) Pub. Date: Aug. 14, 2003

(54) Mobile utility scaffold with cross textured rungs

(76) Inventor: Matthew D. Stringer, Archbold, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/075,769

(22) Filed: Feb. 14, 2002

(51) Int. Cl. E06C 7/00

(52) U.S. Cl. 182/228.2

(57) ABSTRACT

A scaffold system has at least one supporting structure with a first support member, an opposing, second support member, and at least one cross support rung. The rung has an outer surface comprised of a plurality of gripping sections defined by a plurality of grooves.

### FIELD OF THE INVENTION

The present invention relates to a mobile utility scaffold having a cross textured rungs.

### BACKGROUND OF THE INVENTION

Mobile utility scaffolds often present special problems since the scaffolds are typically moved from place to place to in a work environment. Often the scaffolding is used in construction areas either within a building or outdoors where the worker's feet tend to pick up debris. When the worker attempts to climb or mount the scaffold, the footing of the worker can slip.

In the past, various ladder rungs had sections of rough material on a section of the rung, such as shown in Tunstead Des. 182,553 showing a random friction surface; Skala U.S. Pat. No. 4,252,313 shows rungs for a playground equipment having a textured powdered coating with friction enhancing properties.

Other ladder rungs show longitudinally extending rills or grooves such as the Huck U.S. Pat. No. 2,594,561. Stoyer et al. U.S. Pat. No. 3,309,186 shows longitudinally extending teeth. Larson U.S. Pat. No. 3,232,378 shows longitudinally extending flutes or serrations. Werner U.S. Pat. No. 4,656,721 shows a serrated lengthwise extending rung member. Osterwald U.S. Pat. No. 4,698,896 shows hollow longitudinally corrugated sections of sheet metal.

French Patent No. 1082525 shows various ladder rungs, one of which has material displaced into triangular peaks. One problem with this type of rung is that the uneven triangular peaks make the rungs difficult to clean once dirt or debris has been deposited between the triangular peaks.

Also, the rough triangular peaks are abrasive and difficult to grasp with one's hands.

It is therefore an object of the present invention to provide a mobile utility scaffold that provides a secure footing to the worker.

It is a further object of the present invention to provide a mobile utility scaffold with a cross textured rung that is inexpensive to manufacture.

It is yet another object of the present invention to provide a mobile utility scaffold with etched or cross cut textured rungs which scaffold is strong and resistant to breaking and corrosion.

It is still a further object of the present invention to provide a mobile utility scaffold having rungs that provide a secure footing to a worker, while simultaneously providing nonabrasive rungs which are comfortable for gripping with one's hands.

Additional objects and advantages of the present invention will become apparent to those skilled in the art upon consideration of the following detailed description of a preferred embodiment as described herein.

### SUMMARY OF THE INVENTION

A scaffold system has at least one supporting structure. The supporting structure has a first support member and an opposing, second support member, and at least one cross support rung extending therebetween. The rung has an outer generally cylindrical surface and is comprised of a plurality of gripping sections. The gripping sections are defined by a plurality of grooves.

In certain embodiments, the grooves form a pattern on the outer surface of the rung such that each gripping section has a generally uniform dimension. In one particular embodiment, the grooves comprise at least one set of sinusoidal shaped grooves.

In certain embodiments, the grooves can comprise opposing and intersecting first and second sets of sinusoided shaped grooves such that the gripping sections on the outer surface have a square dimension.

In certain embodiments, each gripping section has a slightly arcuate top surface such that the outer surface of the rung has a substantially cylindrical surface. In one embodiment, the grooves have at least one wall that is substantially perpendicular to the top surface of the gripping section. In another embodiment, the grooves have at least one wall that is at an acute angle with respect to the top surface of the gripping section. The rung can be made of a suitable hollow metal pipe.

### BRIEF DESCRIPTION OF THE DRAWINGS

FIG. 1 is a perspective view showing a mobile utility scaffold having opposing scaffold ladders with textured, or engraved, end rungs, and showing optional wheels in phantom.

FIG. 2 is a perspective view of a scaffold ladder having textured or engraved, end rungs, and showing optional wheels in phantom.

FIG. 3 is an enlarged, fragmentary, elevational view of a portion of an end rung of the area shown in FIG. 2.

FIG. 4 is a cross-sectional view taken along the line 4-4 in FIG. 3.

FIG. 5 is an enlarged, cross-sectional fragmentary view of the area 5-5 shown in FIG. 4.

FIG. 6 is an enlarged, cross-sectional fragmentary view of an alternative embodiment of a ladder rung.

### DESCRIPTION OF THE PREFERRED EMBODIMENT

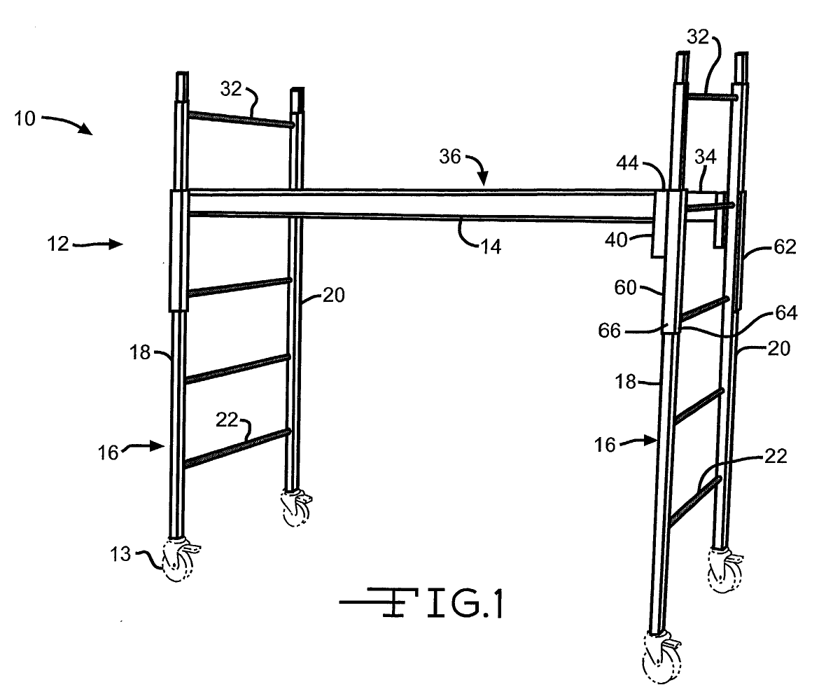

Referring to FIG. 1, a scaffold system 10 is shown as having a scaffold 12, optionally, operatively mounted on individual wheels 13. The scaffold 12 includes a horizontal side rail 14 structure operatively connected to at least one supporting structure or ladder 16. In the embodiment shown, the supporting structure 16 comprises a first, or front, support member or leg 18, operatively connected to a second, or rear, vertical support member or leg 20 and having positioned therebetween at least one, and preferably a plurality of, cross extending rungs or horizontal supports 22. The rung 22 is preferably made of a material such as extruded steel alloys or other suitable materials. Preferably the rung is a hollow metal pipe having a substantially cylindrical or oval longitudinal shape.

It is to be understood that the scaffold system 10 typically comprises an opposing support structure 16′ which is similar to the first support structure 16 which also has a first leg 18′, a second leg 20′ and rungs 22′. For ease of illustration only one support structure will generally be described in detail.

The scaffold 12 further comprises a second horizontal side rail structure 34 which is in opposed and parallel relationship to the first side rail structure 14. A work platform 36 is horizontally positioned between, and is held in position by, the first side rail 14 and the second side rail 34.

In the embodiment shown, the first side rail 14 has a first end 40 which terminates at a guard rail socket 44. Attached to the guard rail socket 40 is a vertically extending channel member 60. The channel 60 is operatively connected to the guard rail socket 40 in a suitable manner. Alternatively, the channel 60 and guard socket 40 can be made as a uniform piece. The channel 60 has a first side 62 and a second, opposing side 64 connected by a base or third side 66.

It is to be understood that, in the embodiment shown, the side rail 14 and the opposing side rail 34 each has opposing ends 40′ which are similar to the first end 40. It is to be further understood that opposing ends 40 and 40′, as shown in FIG. 2, are secured within the vertical support members 18 and 20, respectively, in a suitable manner. In the embodiment, shown the side rail 14 and the side rail 34 each has substantially the same structure such that a guard rail can be either used on a front or rear of the scaffold.

When the side rail 14 is positioned adjacent the first leg 18, the three sides 62, 64 and 66 of the channel 60 are positioned around the support leg 18. In the embodiment shown, the dimensions of the channel 60 and the support leg 18 allow the channel 60 to be easily positioned around the leg 18 such that the channel 60 can be easily moved up and down the leg 18 in order to position the working platform 34 at a desired height.

As shown in FIG. 2, the support legs 18 and 20 define a plurality of spaced apart apertures or openings 70 such that the side rail 14 can be positioned at different heights on the support members 18 and 20, as is described in detail in copending application Ser. No. 09/997,359 and 09/997,363, both of which are expressly incorporated herein by reference. The side rails 14 and 34 are moved and engaged within the apertures 70 on the opposing first and second support legs 18 and 20, respectively.

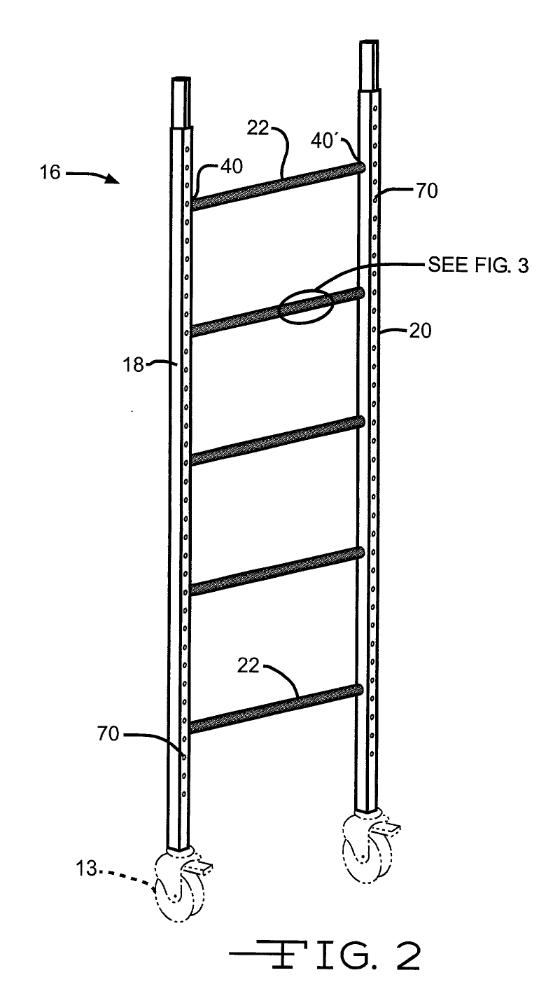

Referring now to FIGS. 3 and 4 an enlarged section of the rung 22 is shown in detail. Preferably, the rung 22 is made of a suitable metal material that can be cut, etched, or machined. The rung 22 has a generally cylindrical outer surface 30 and an inner surface 32. The outer surface 30 defines a plurality of gripping sections 34. In the embodiment shown, each gripping section 34 has substantially the same, or symmetrical, shape. Each section 34, in the embodiment shown, generally has a uniform shape such as a square or a diamond shaped dimension. Each section 34 is formed by cutting or etching a plurality of grooves 36 and 38 in the outer surface 30. It is to be understood that the gripping sections 34 can be formed by any suitable means for cutting or removing metal. As shown in FIG. 4, the grooves 36 and 38 extend into the metal of the rung 22 for a sufficient distance to give the rung 22 a desired generally cylindrical, yet textured, outer surface 30. The patterned outer surface 30 of the rung 22 provides a desirable nonslipping and secure traction surface on the rung 22.

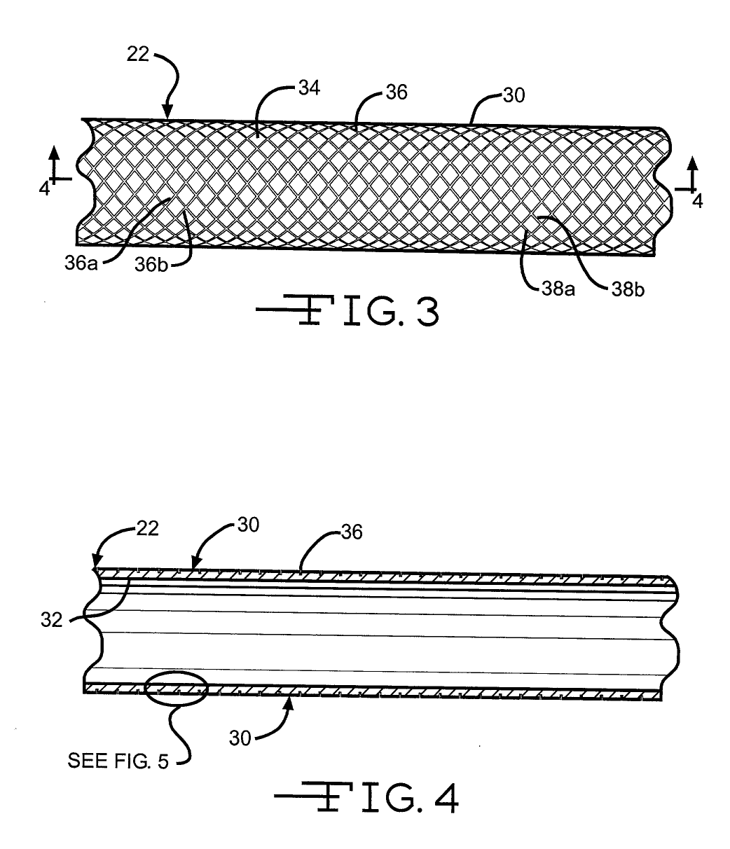

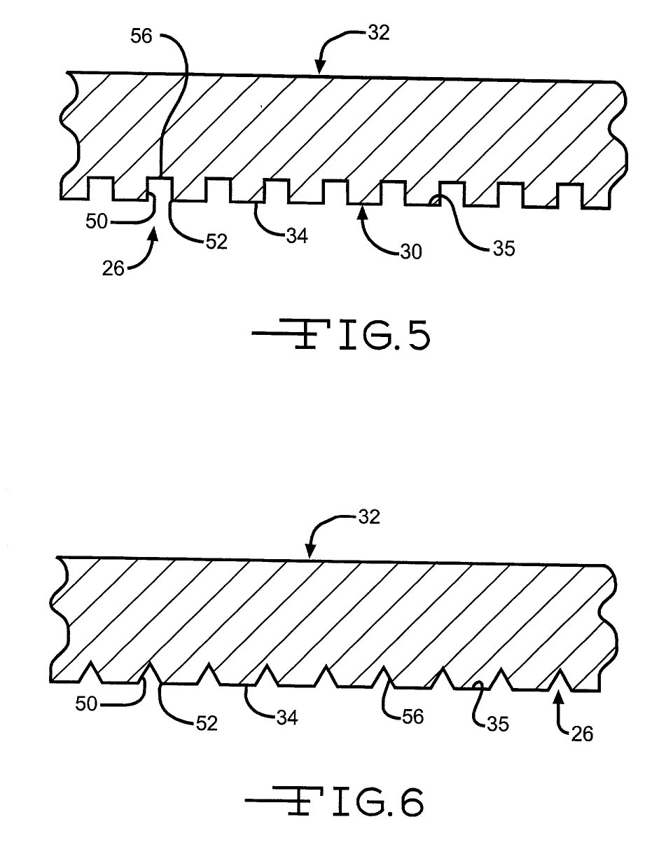

FIG. 5 shows an enlargement of the area shown in FIG. 4. For ease of illustration, only one groove 36 will be described in detail. It should be understood, however, that all the grooves 36 and 38 can generally have the same configurations. The groove 36 generally has opposing side walls 50 and 52. The groove 36 terminates at a distal end 56. At least one of the side walls 50 and 52, or both of the side walls 50 and 52, as shown in FIG. 5, can extend in a perpendicular direction from a plane defined by the top surface 35 of the gripping section 34. In another embodiment, at least one of the side walls 50 and 52, or both of the side walls 50 and 52, as shown in FIG. 6, can extend at an acute angle to a top surface 35 of the gripping section 34 such that the grooves have a substantially V-shape.

In the embodiment shown in FIG. 3, each gripping section 34 is defined by adjacent and intersecting grooves 36 and 38. The dimensions of the area of the top surface 35 of the gripping section 34 are defined by how spaced apart one groove 36 a in a first set of grooves 36 is from an adjacent groove 36 b in the first set of grooves 36 and how far apart another groove 38a in a second set of grooves 38 is from an adjacent groove 38b in that second set of grooves 38. If the first set of grooves 36 intersects the second set of grooves 38 at substantially a right angle, the area of the top surface 35 has a square, or diamond shape.

If the distance between grooves 36 a and 36 b is the same as the distance between grooves 38a and 38b, then the top surface 35 has a square shape. If the distance between grooves 36 a and 36 b is different from the distance between grooves 38a and 38b, then the top surface 35 has a rectangular shape.

Each top surface 35 has a slightly arcuate surface. The plurality of top surfaces 35 defines the overall cylindrical surface of the outer surface 30 of the rung 22. Thus, the generally overall cylindrical outer surface 30 is comprised of the top surfaces 35 of the plurality of gripping sections 34.

The top surface 35 of the gripping section 34 and the spaced apart grooves 36 provides a desired nonslip surface for the worker. Also, since the worker often climbs on the support leg 18 to various distances, the worker often grabs the outer surface 30 of the rung 22 with his hands. The gripping sections 34 allow the worker to grab the rung 22 without causing any damage or scraping, while still providing a nonslip surface.

Referring again to the embodiment of FIG. 3, the grooves 36 and 38 are suitably cut or etched into the outer surface 30. A first set, or plurality, of parallel extending and equally spaced apart grooves 36 form sinusoidal patterns on the outer surface 30. A second set, or plurality of parallel extending and equally spaced apart grooves 38 also form sinusoidal patterns on the outer surface 30. The first and second sets of sinusoidal grooves 36 and 38, respectively, define the gripping sections 34 and provide the rung 22 with a preferred pattern on the outer surface 30.

In use, the support structure, or ladder, 16 is most often used in a substantially vertical direction such that the worker climbs at a 90° angle with respect to whatever surface the scaffold 12 is positioned upon. The outer surface 30, formed by the gripping sections 34 and grooves 36 and 38, of the rung 22 allows the worker to feel secure both when positioning the worker's hands and feet on the rung 22. The cross-textured rung 22 prevents any damage to the hand and simultaneously prevents any slipping of the feet. Further, the pattern of multiple sinusoidal grooves 36 and 38 extending along the length of the rung 22 allows the worker to position his hand or foot at any point along the rung.

The depth of the walls 52 and 54 is sufficient to allow the nonslip outer surface 30 to be formed, yet allows the worker to contact the rung 22 with his bare hands and not cause damage or scrapes. Further, the width and the depth of the grooves 36 and 38 are preferably such that the scaffold rungs 22 can be easily cleaned of any debris which may be deposited within the grooves 36 and 38 during the use of the scaffold.

The opposing sets of sinusoidal grooves 36 and 38 on the outer surface 30 of the rung 22 are deep enough to provide the rung 22 with a secure, non-slip and nonabrasive surface, yet the grooves 36 and 38 are sufficiently shallow to provide the rung with the necessary tensile strength during use.

Although the invention has been described in detail with reference to a certain preferred embodiment, variations and modifications exist within the scope and spirit of the invention as described and defined in the following claims.

I claim:

1. A scaffold system having comprising at least one supporting structure having a first support member and an opposing, second support member, and at least one cross support rung extending therebetween, the rung having an outer surface comprised of a plurality of gripping sections defined by a plurality of grooves.

2. The scaffold system of claim 1, wherein the grooves form a pattern on the outer surface of the rung.

3. The scaffold system of claim 2, wherein the grooves comprise at least one set of spaced apart sinusoidal shaped grooves.

4. The scaffold system of claim 3, wherein the grooves comprise opposing first and second sets of sinusoided shaped grooves.

5. The scaffold system of claim 4, wherein the grooves intersect at substantially right angles.

6. The scaffold system of claim 5, wherein the gripping section has a square top surface.

7. The scaffold system of claim 6, wherein the gripping section has an arcuate surface whereby the outer surface of the rung has a substantially cylindrical surface.

8. The scaffold system of claim 7, wherein the grooves have at least one wall that is substantially perpendicular to the top surface of the gripping section.

9. The scaffold system of claim 7, wherein the grooves have at least one wall that is at an acute angle with respect to the top surface of the gripping section.

10. The scaffold system of claim 1, wherein the rung is a hollow metal pipe.
